(19) United States
(12) Patent Application Publication
(10) Pub. No.: US 2014/0211471 A1
(43) Pub. Date: Jul. 31, 2014

(54) ELECTRIC CANDLE

(71) Applicant: Joern Gaumann, Dortmund (DE)

(72) Inventor: Joern Gaumann, Dortmund (DE)

(73) Assignee: GMS GMBH, Dortmund (DE)

(21) Appl. No.: 14/346,835

(22) PCT Filed: May 9, 2012
(86) PCT No.: PCT/EP2012/058531

§ 371 Date: Mar. 24, 2014

(30) Foreign Application Priority Data
Sep. 27, 2011 (DE) 20 2011 106 610.3

(51) Int. Cl. F21V 35/00; F21S 10/04; F21S 6/00; F21K 99/00

(52) U.S. Cl. CPC F21V 35/00; F21K 9/1355; F21S 10/04; F21S 6/001
USPC 362/249.02; 362/249.01

(57) ABSTRACT

An electric candle has a candle body and at least two lighting devices which are arranged in the candle body. In order to develop the electric candle further in such a way that the user perceives it in a more aesthetically pleasing fashion, the candle wick is made of a transparent or translucent material and the candle body constitutes a casing. The interior of the candle is embodied as a cavity in which the lighting devices are arranged.

The invention relates to an electric candle, having a candle body and at least two lighting means disposed in the candle body.

Electric candles of the type stated initially are sufficiently known and have at least one electrically operated lighting means that is generally integrated into the candle body. The candle body is formed of wax or another translucent material, for example. The lighting means integrated into the candle body illuminates the candle body from the inside in one variant.

In the documents U.S. Pat. No. 3,749,904 and WO 2006/104898 A1, electric candles are disclosed that have a candle body and at least two lighting means disposed in the candle body. In this connection, the lighting means are either incorporated directly into the candle body, which consists of wax (U.S. Pat. No. 3,749,904), or disposed within a cavity that is situated in the lower region of the candle body, which consists of wax, and consequently takes up only a part of the candle body (WO 2006/104898 A1).

In a further variant of the candle of the type stated initially, the lighting means is disposed in the interior of the candle body, in such a manner that the light beams are emitted into a flame-shaped structure that is situated on the upper face-side end of the candle and is produced by means of a translucent or transparent material. In this way, the appearance of a flame of a conventional candle is simulated when electricity is supplied. In this connection, the internal structure of the previously known electric candle is structured, in the simplest case, in such a manner that the lighting means is connected with an electricity source, which is configured as a battery or rechargeable battery, for example, by way of lines and a switch.

The development and further development of electric candles is based on the recognition that burning down of candles continues to be a possible cause of fire damage.

Electric candles represent a proven instrument for preventing fire damage caused by improper use by the consumer. Of course, a prerequisite for this is that electric candles find increased acceptance among consumers. This acceptance among consumers is achieved, last but not least, by the esthetic appearance of electric candles, which reproduces the appearance of conventional candles with their light effects.

It is therefore the task of the present invention to technically develop an electric candle of the type stated initially further, in such a manner that a more pleasing esthetic perception by the consumer is achieved.

This task is accomplished with the characteristics of claim 1. Advantageous embodiments of the invention are evident from the dependent claims.

The invention provides that the electric candle is provided with a candle wick that is formed from a transparent or translucent material.

An additional light effect is created by the light irradiation of the candle wick, which can preferably be configured not only to be hollow but also as an elongated, cylindrical piece of material, which effect leads to a more pleasing esthetic perception and thereby to increased acceptance among more than a few consumers. In this connection, the light irradiation of the candle wick can be configured in different colors.

The advantage of the invention can therefore be seen in that a further lighting effect occurs as a result of the transparent or translucent material, in addition to the flame-shaped structure that encloses the candle wick. Thus, the electric candle demonstrates multiple illuminated sections that are brought about by means of at least two lighting means integrated into the candle body.

Furthermore, in contrast to the state of the art, the candle body represents a casing, so that the entire candle body is configured as a cavity. This has the advantage that the lighting means illuminate the entire cavity and thereby are able to achieve a greater lighting effect, therefore in turn achieving a more pleasing esthetic perception by the consumer.

In this connection, an advantageous embodiment of the invention provides that the lighting means is an LED. A long period of operation of the electric candle is guaranteed by an LED.

In order to maintain the natural form of a conventional candle, at least in part, it is advantageous that the candle body is made of wax. However, it is also possible that the candle body is made of a different translucent material, such as glass or plastic, for example.

In the following, the invention will be explained in greater detail using the drawings. These show, in a schematic representation:

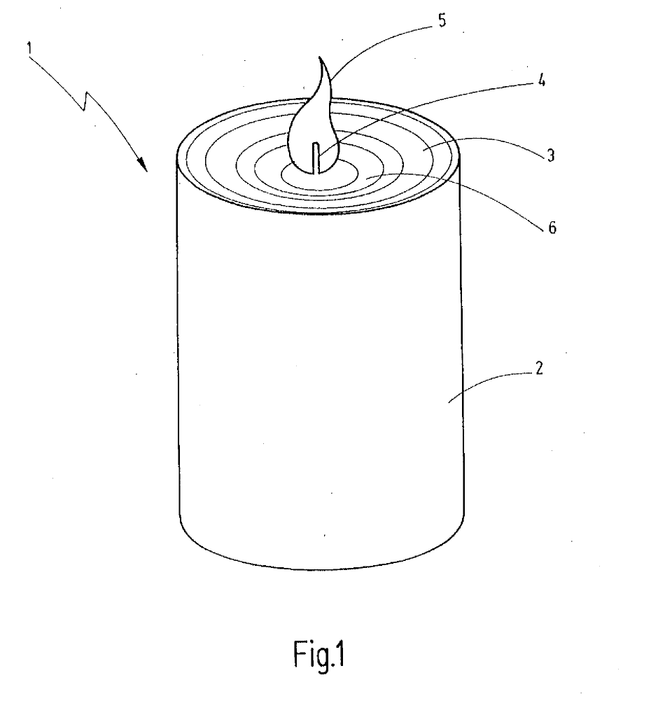

FIG. 1 a perspective view of an electric candle according to the invention, and

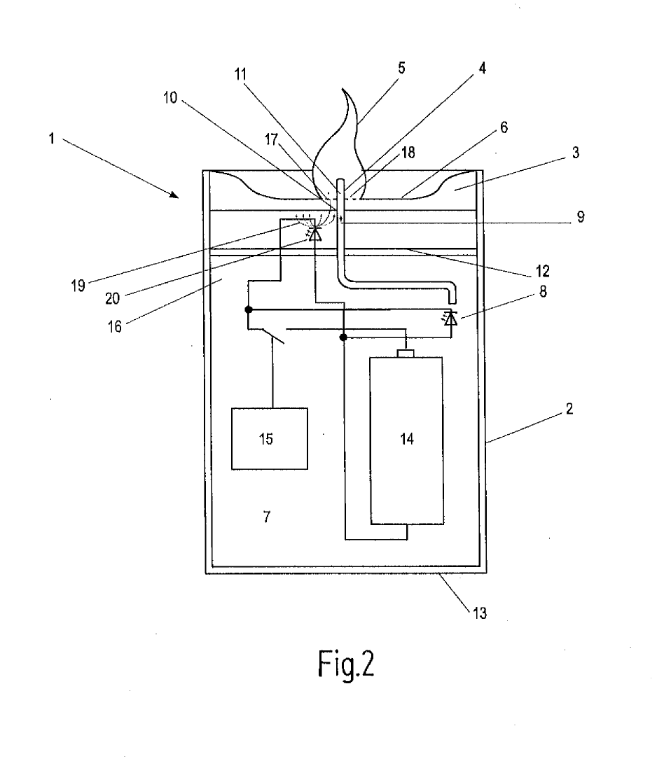

FIG. 2 a longitudinal section through the electric candle according to the invention.

FIG. 1 shows an electric candle that is provided with the reference symbol 1.

The electric candle 1 comprises a candle body 2 having the shape of a candle, which is configured to be cylindrical in the embodiment shown in FIG. 1. The candle body 2, which is formed from wax or another translucent material, for example, represents a casing, i.e. a cavity 7 shown in FIG. 2 is configured in the interior of the electric candle 1.

On its upper face-side end 3, the candle body 2 has a depression 6. The external look of a candle that has been burned for a short time is given by the depression 6.

In a manner essential to the invention, the upper face-side end 3 has a candle wick 4 in its center, which wick is produced from a transparent or translucent material. In the embodiment shown in FIG. 1, the translucent material of the candle wick 4 is a glass-fiber-reinforced plastic, which can be provided with a dark casing and is also referred to colloquially as fiberglass.

On the top face-side end 3, a flame-shaped structure 5 extends upward, so that the candle wick 4 is enclosed in the flame-shaped structure 5, which is also produced from a transparent or translucent material. The flame-shaped structure 5 is shaped to imitate a conventional flame, so that here, too, the look of a conventional candle exists.

As is evident from FIG. 2, which shows the interior of the candle body 2, the candle wick 4 projects partially into the upper face-side end 3 of the candle body 2, while the opposite end of the candle wick 4 stands away from the upper face-side end of the candle body 2.

Below the candle wick 4, i.e. in the interior of the candle body 2, there is the lighting means 8 that emits light beams 9 through the opening 10 of the candle wick 4 into the interior 11 of the candle wick 4 configured as a hollow body. The lighting means 8, 20 are situated on or under an intermediate plane 12 that is produced from plastic, for example, and runs parallel to the lower face-side 13 of the candle body 2 and carries at least one of the lighting means 8, 20.

In the interior of the candle body 2, there is a circuit that is formed from the lighting means 8, 20, the power supply 14, which is present as a battery in the embodiment shown in FIG. 2, as well as the switch 15. The lighting means 8, 20 are supplied with electricity by way of the lines 16.

In the embodiment of the electric candle 1 according to the invention shown in FIG. 2, both the candle wick 4 and the flame-shaped structure 5 project into the upper face-side end 3. On the underside of the latter, there is an opening 18 through which the emitted light 19 of the lighting means 20, which is preferably present as a light-emitting diode, gets into the interior of the flame-shaped structure 5 configured as a hollow body. The candle wick 4 is present in the form of an elongated, cylindrical piece of material that is illuminated by the emitted light 9 of the lighting means 8. The candle wick 4 is fastened onto a crosspiece 17, the two end sides of which are connected with the edge of the opening 18, and which does not completely cover the opening 18, so that emission of the light 19 into the interior of the flame-shaped structure 5 is guaranteed.

The present invention is not restricted, in terms of its embodiment, to the exemplary embodiment indicated above. Instead, a number of variants is possible, which make use of the solution presented also in embodiments that are of a different type.

For example, the lighting means 8, 20 can comprise multiple LEDs. Also, the electric candle 1 can be equipped with further additional functions, such as, for example, a timer function, i.e. the electric candle is turned on or shut off automatically after a certain time, or a color-change LED. Also, the electric candle can be additionally provided with a rechargeable battery or with a recharging function.

### REFERENCE SYMBOL LIST

1 candle

2 candle body

3 face-side end

4 candle wick

5 flame-shaped structure

6 depression

7 cavity

8 lighting means

9 light beams

10 opening

11 the interior

12 intermediate plane

13 lower face side

14 power supply

15 switch

16 line

18 crosspiece

18 opening

19 light beams

20 lighting means

1. Electric candle (1), having a candle body (2) and at least two lighting means (8, 20) disposed in the candle body (2),
wherein
it has a candle wick (4) made of a transparent or translucent material, and the candle body (2) represents a casing, wherein the interior of the candle (1) is configured as a cavity (7) in which the lighting means (8, 20) are disposed.

2. Candle according to claim 1,
wherein
the material is glass-fiber-reinforced plastic.

3. Candle according to claim 1,
wherein
the candle body (2) is formed, at least in part, from wax and/or a translucent material,

4. Candle according to claim 1,
wherein
the candle wick (4) is enclosed in a flame-shaped structure (5) that is formed from a transparent or at least translucent material.

5. Candle according to claim 1,
wherein
the lighting means (8, 20) are disposed below the candle wick (4).

6. Candle according to claim 1,
wherein
the lighting means (8, 20) are a light-emitting diode.

7. Candle according to claim 1,
wherein
the candle wick (4) projects into an upper face-side end (3) of the candle body (2).

8. Candle according to claim 1,
wherein
the candle wick (4) is disposed on the upper face-side end (3) of the candle body (2).

9. Candle according to claim 1,
wherein
the candle wick (4) is provided with a dark casing.

10. Candle according to claim 1,
wherein
the lighting means (8, 20) are situated on or under an intermediate plane (12) that runs parallel to the lower face-side (13) of the candle body (2) and carries at least one of the lighting means (8, 20).

11. Candle according to claim 1,
wherein
there is a circuit in the cavity (7).

12. Candle according to claim 11,
wherein
the circuit is formed from the lighting means (8, 20), the power supply (14), as well as a switch (15).

13. Candle according to claim 4,
wherein
the candle wick (4) is fastened onto a crosspiece (17), the two end sides of which is connected with the edge of an opening (18), and which does not completely cover the opening (18).

14. Candle according to claim 4,
wherein
there is an opening (18) on the underside of the flame-shaped structure (5).
